(19) United States
(12) Patent Application Publication
(10) Pub. No.: US 2009/0097687 A1
(43) Pub. Date: Apr. 16, 2009

(54) Diaphragm for a Condenser Microphone

(75) Inventor: James S. Collins, Elk Grove Village, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: KNOWLES ELECTRONICS, LLC, Itasca, IL (US)

(21) Appl. No.: 11/873,143

(22) Filed: Oct. 16, 2007

(51) Int. Cl. H04R 9/08

(52) U.S. Cl. 381/369

(57) ABSTRACT

A microphone for transducing between an acoustical signal and an electrical signal, comprises a housing and a motor assembly disposed within the housing. The motor assembly includes a backplate and a diaphragm attached to the backplate via a spacer. The diaphragm comprising a ring and a film, the diaphragm vibrates in response to an acoustical signal, wherein the film is formed from an amorphous or semi-crystallized polyphenylene sulfide (PPS) and a metal layer is attached to the film. The film is completely covered by the metal layer and a portion of the metal is removed using a direct energy source, leaving a portion of the film directly exposed resulting in reducing the parasitic capacitances between the backplate and the diaphragm and increasing the sensitivity. Alternatively, the film is partially covered by the metal layer. At least one opening is formed on the microphone and acoustically/electrically coupled to an opening formed on a main printed circuit board of an electronic device, defining a surface mountable microphone.

### TECHNICAL FIELD

This patent generally relates to transducers, and more particularly, to a diaphragm with improved humidity sensitivity for the motor assembly of a condenser microphone.

### BACKGROUND OF THE INVENTION

Electret condenser microphones generally include a housing and a motor assembly disposed within the housing. The motor assembly may include a backplate and a diaphragm. A metal layer is attached to a Mylar film, stretched across and adhesively attached to a metal ring to serve as a diaphragm. The sensitivity of the microphone is related to the tension in the film. Temperature and humidity affect the film and may cause dimensional changes, which can lead to instability with environmental changes and generally over time. Microphone sensitivity changes is a particular problem when microphones are used as matched pairs because the individual microphones of the match pairs tend to drift apart.

Parasitic capacitance also exists between the backplate and the diaphragm in the portion of the diaphragm fixedly attached to the backplate and potentially an inner surface of the housing. This can be overcome by leaving the peripheral portions of the diaphragm uncoated with the conductor, i.e., the metal layer. However, selective deposition of the metal layer to the Mylar film and leaving the corners or periphery exposed presents manufacturing difficulties and may not yield sufficient capacitance reduction to justify the effort.

In addition to the size of many applications, including electronic devices, telecommunication devices, and hearing instruments are becoming smaller, and limited space is available to accommodate the microphone. Typically, the microphone includes an opening formed on a circuit board attached to one end of the cup-shaped cover. Sound is directed from a port formed on the main PCB and to the microphone via the opening of the circuit board. To provide electrical coupling for the microphone to an external component formed on the opposite side of the main PCB, requires extra space to accommodate a separate opening formed on the microphone. This leads to additional and expensive process.

### BRIEF DESCRIPTION OF THE DRAWINGS

For a more complete understanding of the disclosure, reference should be made to the following detailed description and accompanying drawings wherein:

FIG. 1 is an exploded view illustrating a condenser microphone according to a described embodiment of the invention;

FIG. 2 is a perspective view of the microphone of FIG. 1;

FIG. 3 is an enlarged partial view of a motor assembly of the microphone assembly shown in FIG. 1;

FIGS. 4A-4C are cross-sectional views of a diaphragm assembly, in accordance with various embodiments of the invention;

FIG. 5 is a flow chart illustrating a manufacturing process of a diaphragm embodying the teachings of the invention;

FIG. 6 is a top view of another exemplary diaphragm assembly, in accordance with various embodiments of the invention;

FIG. 7 is a top view of another exemplary diaphragm assembly, in accordance with various embodiments of the invention; and

FIG. 8 is a simplified cross-sectional view of a surface mountable microphone according to a described embodiment of the invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

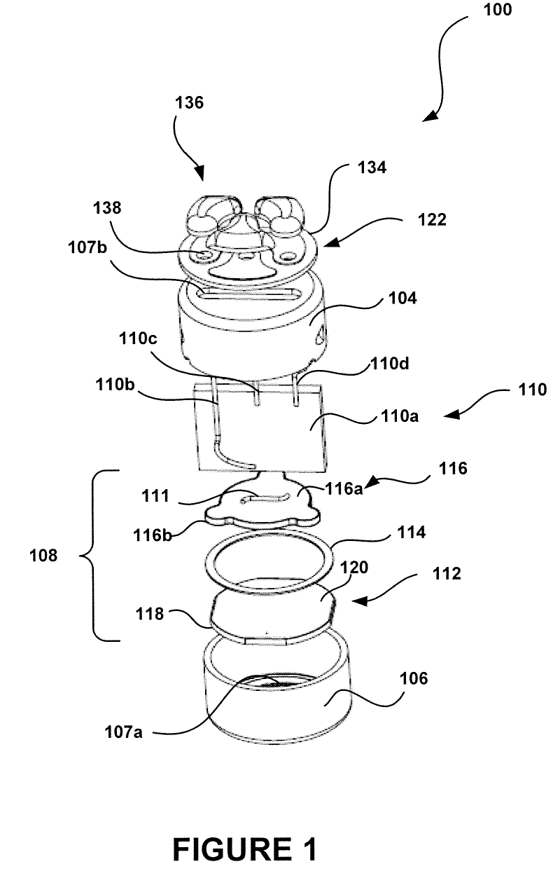

FIG. 1 illustrates an exploded view of a transducer 100 that can be used in virtually any type of electronic device, gaming device, communication device, entertainment device, listening device (e.g. earphones, headphone, Bluetooth wireless headset, insert earphone, UWB wireless headset, hearing aid) and the like. When used in hearing aids, such devices may be a behind-the-ear (BTE), in-the-ear (ITE), in-the-canal (ITC), completely-in-the-canal (CIC), combined BTE/ITE, combined BTE/ITC, combined BTE/CIC, or the like type hearing aids. Other types of listening device are possible.

The transducer 100 may be a receiver, a speaker or a microphone, or in combinations may be a combined receiver and microphone, dual microphones, dual receivers, depending on the desired applications. In the embodiment shown, the transducer 100 is a microphone. The microphone 100 may include a housing 102 having a cover assembly 104 and a bottom assembly 106 attached to the cover assembly 104 by any known techniques to retain the working components. While the housing 102 has a cylindrical shape, it will be understood that any housing shape or configuration suitable for a desired application may be used, including a roughly square shape, a rectangular shape or any other desired geometry and size. The assemblies 104, 106 may be manufactured from a variety of materials such as, for example, stainless steel, alternating layers of conductive and non-conductive materials (e.g. metal particle-coated plastics), or the like.

At least one opening 107a, 107b is formed on the housing 102 by any known technique to permit acoustic signals to enter and interact with the working components disposed within the housing 102. Further, the openings 107a, 107b allow electrical connection from an external component to the internal components within the housing 102. The microphone 100 further comprises a motor assembly 108 and a circuit assembly 110 attached to the motor assembly 108 by an integral connecting wire 111. The motor assembly 108 may be directly or indirectly stacked over or under the circuit assembly 110. Alternatively, the assemblies 108, 110 may be arranged serially in a non-stacked configuration. An electronic device (not shown) is mounted to a circuit board 10a of the circuit assembly 110. The electronic device may be an integrated circuit (IC) die, a capacitor, a resistor, an inductor, or other device including passive devices, depending on the application. The circuit assembly 110 may further include connecting wires 110b, 110c, 110d that provide a ground, a power supply input, and an input for the process electrical signal corresponding to a sound that is transduced by the motor assembly 108.

The motor assembly 108 includes a diaphragm 112, a spacer 114, and a backplate 116. The spacer 114 is placed between the diaphragm 112 and the backplate 116. The spacer 114 may have the form of an annular ring shape and may correspond to the internal configuration of the housing 102. It may typically be manufactured of an electrically insulating material such as polyethylene terephthalate (PET), polyimide, plastic, or the like. Other types of material are possible.

The backplate 116 may have virtually any form of shape or configuration suitable for the application, including a roughly square shape, a rectangular shape or any other desired geometry and size with or without a backplate support and correspond to the configuration of the spacer 114 includes a conductive layer 116a and a charged layer 116b. The charged layer 116b may be chosen from a set of materials that are thermoplastic materials with suitable charge storage characteristics, chemical resistance, and temperature stability. In one embodiment, the charged layer 116b may be a fluorinated ethylene propylene material commonly available under the trade name TEFLON, or any similar materials. Other types of material may be used. The conductive layer 116a may be made of an electrically conductive material such as a stainless steel, gold, metal particle-coated polymer, or the like for transmitting signals from the charged layer 116b. Other types of material are possible. An optional polymer layer (not shown) may be attached to the conductive layer 116a by any known technique.

The diaphragm 112 includes a ring 118 and a film 120 attached to the ring 118 by any known technique. More details about the formation of the diaphragm 112 will follow. It will be understood that the operation of the microphone 100 is generally based on the change in capacitance and resulting electrical signal that may be generated as a result of movement of the film 120 of the diaphragm 112 responsive to the exposure to sound pressure relative to the fixed electrode on the charged layer 116b of the backplate 116. The sound pressure may be the result of acoustic energy presented in front of the ear canal, or from other sources.

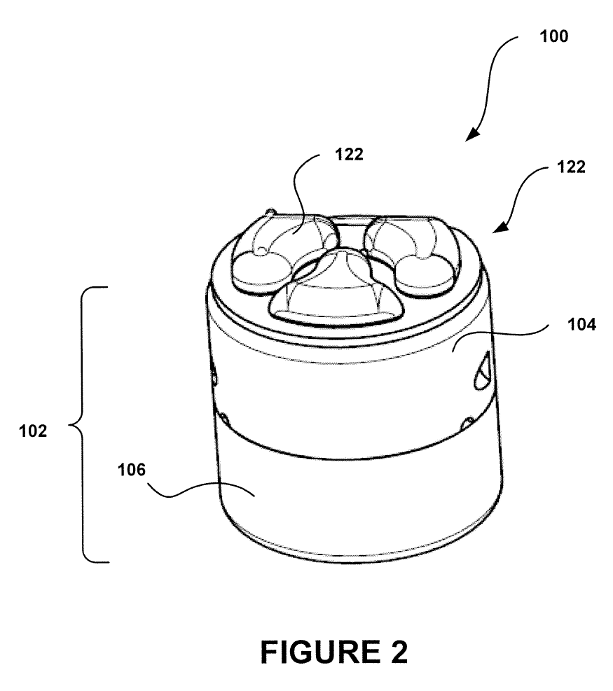

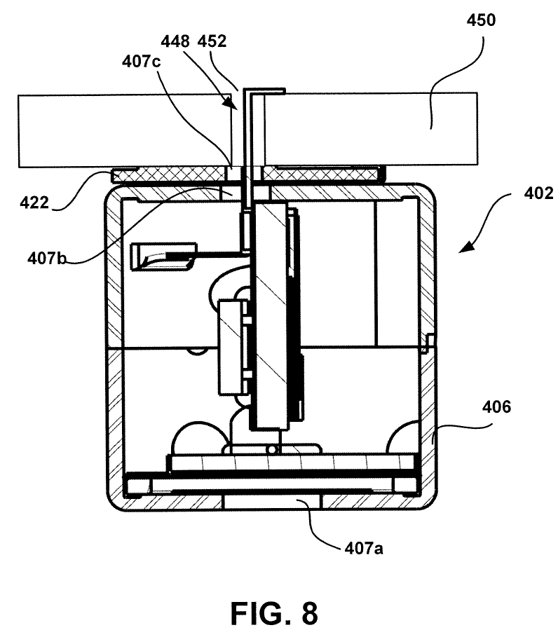

FIG. 2 illustrates a perspective view of a microphone 100. A diaphragm 112, as depicted in FIG. 1 as part of a motor assembly 108, is disposed within a housing 102. A flex circuit assembly 122 includes at least one terminal pad 122, three are illustrated, to permit connecting to an external device (not shown). The external device may be a printed circuit board (PCB), a transducer, or other portion of an electronic device or an electronic device. As shown, the flex circuit assembly 122 is attached to a cover 104 of the housing 102. An optional opening (not shown) may be formed on the flex circuit assembly 122 and aligned with an opening 107b (as shown in FIG. 1) to allow acoustic energy to enter and exit the housing 102 and/or electrical connecting to an circuit assembly 110 and/or motor assembly 108. The dimension of the opening (not shown) on the flex circuit assembly 122 may be smaller than, bigger than, same as the opening 107b as long as the dimension of both of the openings is sufficient to accommodate both functions as mentioned earlier. Optionally, an opening having a dimension, smaller than, bigger than, or same as the openings of the flex circuit assembly 122 and the cover 104, may be formed on the main PCB (as shown in FIG. 8), aligned with and/or overlapped the openings to allow acoustic signal to flow in and out of the microphone 100 and/or to provide electrical connection to other electronic components formed on the other side of the main PCB that is opposite to the microphone 100. An opening 107a may be sealed if an acoustic port is formed on the flex circuit assembly 122 and the cover 104, defining an omni-directional microphone.

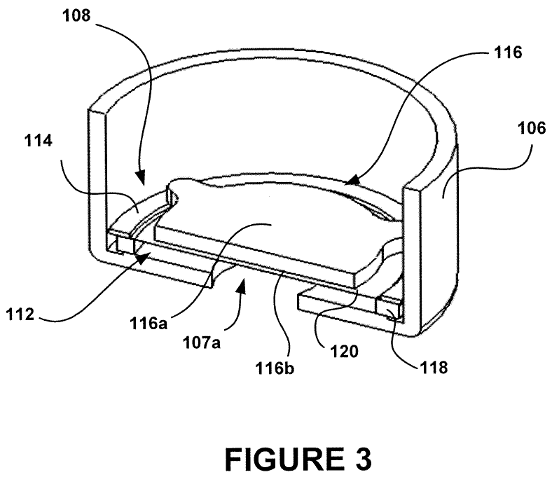

FIG. 3 illustrates a motor assembly 108 disposed within a bottom housing portion 106 of a microphone 100 as depicted in FIG. 1. The motor assembly 108 may include a backplate 116, a spacer 114, and a diaphragm 112. The spacer 114 is sandwiched between the backplate 116 and the diaphragm 112. As shown, the backplate 116 is placed over the diaphragm 112 while the diaphragm 112 is attached to the inner surface of the bottom housing portion 106. However, it will be understood that the backplate 116 may be attached to the inner surface of the bottom housing portion 106 with the diaphragm 112 being stacked over the backplate in closer relationship to the circuit assembly 110, depending on the application. More than one backplate and/or diaphragm may be attached to the motor assembly 108, without departing from the scope of the invention.

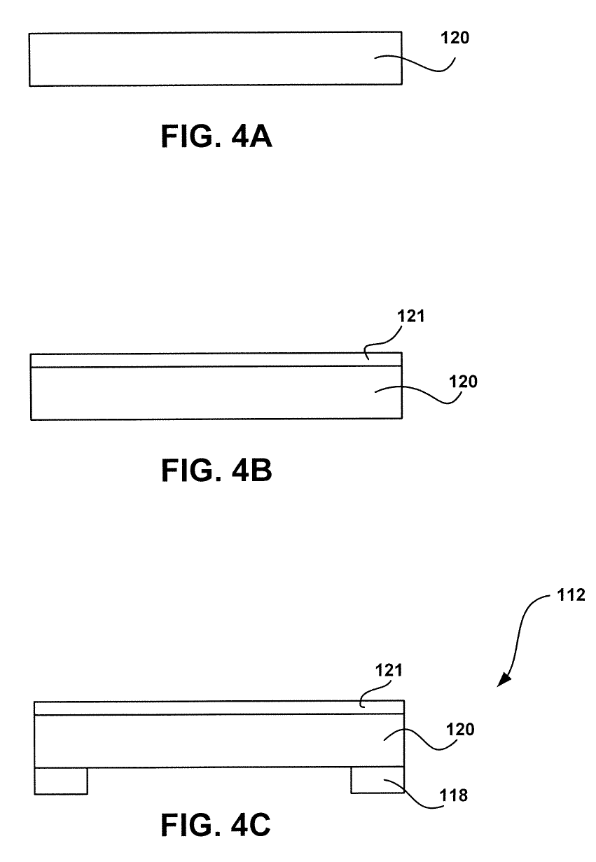

FIGS. 4A-4C illustrate one example of a diaphragm 112 used in a microphone 100. The diaphragm 112 includes a ring 118 and a film 120 attached to the ring 118. The ring 118 may be made of stainless steel; however, any non-conductive material or conductive material including a conductive coating, brass or tin may be utilized. A metal layer 121 such as nickel, gold, titanium, or chrome is formed on a first surface of the film 120 by any suitable technique, including thermo-evaporation or sputtering. Other types of material and application techniques may be used. The film 120 of the diaphragm 112 is made of a dielectric film such as polyphenylene sulfide (PPS). The metallized PPS film 120 undergoes a heating process having a heating temperature ranging between 200 degree C. and 450 degree C. to modify the crystallization of the PPS, defining a metallized amorphous or semi-crystallized PPS film 120. The metallized semi-crystallized PPS film 120 then undergoes a stress annealing process by applying stress and heat to the film 120, cooling the film to room temperature and biaxially stretching the film to achieve as substantially uniform tension throughout the metallized semi-crystallized PPS film 120. Finally, a ring 118 is attached to the film 120 forming the diaphragm 112.

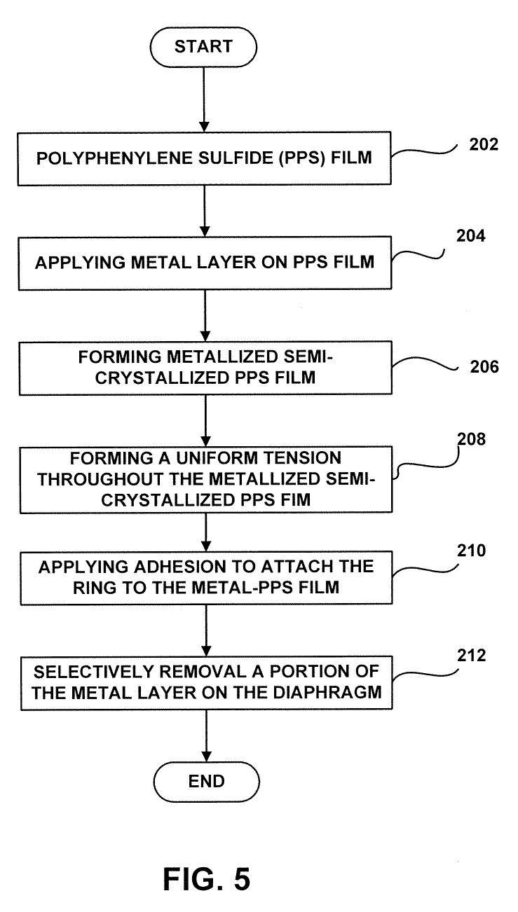

FIG. 5 is a flow chart illustrating a manufacturing process of a diaphragm 112 used in a microphone 100. At 202, a dielectric film such as PPS is provided. Other types of material having similar or equivalent material properties may be used without departing from the scope of the invention. A thin metal layer such as gold is applied to one surface of the PPS film by a suitable technique, 202. The surface of the PPS film may be partially or completely covered by the gold layer. The metalized PPS film is then placed on a fixture, ready for a crystallization process, which can be achieved by heating, for example. Other crystallization processes including chemical, mechanical stress and the like may be used. A heating cyrstalization process can be carried out at a heating temperature ranging between 230 degree C. and 450 degree C., 206, to modify the crystallization of the PPS film. Once the metallized semi-crystallization PPS film is formed, a stress annealing process, 208, may be performed. Generally, a stress is applied to the film at a temperature approximately 200 degree, cooling the film to room temperature, and biaxially stretching the film until a tension is maintained uniformly throughout the film. An adhesive is applied for attaching a ring to the film, forming a diaphragm 112.

A portion of the metallization may then be removed from the diaphragm. For example, a direct energy source, such as excimer laser, capable of selectively removing the diaphragm metallization without damaging the diaphragm is utilized.

The diaphragm 112 using a PPS material has improved humidity sensitivity. Its advantages are useful in directional microphones, whether the directional microphone is in the form of two separate omni directional microphones matched together or a single microphone housing with two motor assemblies, or by other methods of making the microphone have directional characteristics. Because the diaphragm made of PPS material provides is more stable in the presence of humidity, matching of the pairs of microphones or motor assemblies can be achieved for longer periods of time.

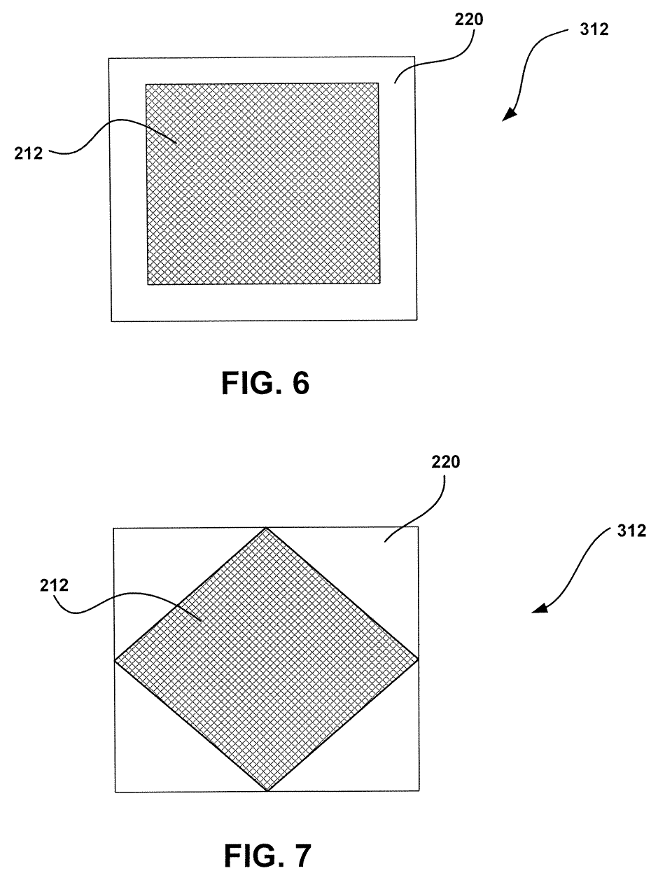

FIGS. 6-7 illustrate another example of a diaphragm, diaphragm 312 for a microphone 100. A device (not shown) may be used to direct an energy source to the metal layer 321 of the diaphragm 312 so as to alter or remove at least one region of the metal layer 321 and leaving at least one unaltered region. In one embodiment, the directed energy source is an excimer laser capable of ablation of the material or altering the molecular bonds structure of the diaphragm metallization. Chemical or mechanical etching or other suitable processes may be used in place of the energy source process to remove the portion of metal layer 321.

An advantage of the herein described construction is that when the charged layer 116b of the backplate 116 attaches to a portion of the semi-crystallized PPS film 320 in which the metal layer is removed via the spacer 114 (As shown in FIG. 1), stray or parasitic capacitance may be reduced further increasing the sensitivity. Also, the signal to noise ratio of the microphone 100 is thereby improved. The metal layer 321 having a thickness, typically in the range of 100 Å and 300 Å. While the metal layer 321 as shown in FIG. 6 has a square shape, leaving the peripheral portion of the PPS film 320 exposed, resulting in reduced parasitic capacitance and increased sensitivity, e.g. covering the central vibratory portion of the semi-crystallized PPS film 320 and leaving at least a portion of the diaphragm attaching to the backplate 116 exposed. It will be understood that any shape or configuration, including a rectangular shape, circular shape, ovular shape, octagonal shape, diamond shape or any other desired geometry and size may be used.

FIG. 8 illustrates a surface mountable microphone 400 mounted to a main printed circuit board (PCB) 450 of an electronic device, such as a cellular phone (not shown). Openings 407b, 407c are formed on a housing 402 and a flex circuit 422. An opening 452 is formed on the main PCB and overlaps the openings 407b, 407c, defining a passageway, 448 to accommodate acoustic coupling and electrical coupling. The dimension of the openings 407b, 407c, may be smaller than, bigger than, same as the opening 452 as long as the dimension of the openings is sufficient to accommodate both functions as mentioned earlier. An opening 407a formed on the opposite side of housing, e.g. the bottom housing 406 may be sealed, defining an omni-directional microphone. Optionally, the surface mountable microphone 400 may be a directional microphone, leaving the opening 407a unsealed.

It will be appreciated that numerous variations to the above-mentioned approaches are possible. Variations to the above approaches may, for example, include performing the above steps in a different order. For instance, a modified PPS film is used before the metal layer is applied to the film so that the step to modify the crystallinity of the metallized diaphragm is no longer required.

All references, including publications, patent applications, and patents, cited herein are hereby incorporated by reference to the same extend as if each reference were individually and specifically indicated to be incorporated by reference and were set forth in its entirety herein.

Preferred embodiments of this invention are described herein, including the best mode known to the inventors for carrying out the invention. It should be understood that the illustrated embodiments are exemplary only, and should not be taken as limiting the scope of the invention.

What is claimed:

1. A motor assembly for a microphone for transducing between an acoustical signal and electrical, comprising:
a backplate comprising a charged layer and a conductive layer; and
a diaphragm opposed to the backplate comprising a metal layer and a film, the film vibrates in response to sound pressure relative to a fixed electrode on the charged layer, is formed from a modified dielectric material having a uniform tension.

2. The motor assembly of claim 1, wherein the material is semi-crystallized polyphenylene sulfide.

3. The motor assembly of claim 1, wherein a spacer is provided between the backplate and the diaphragm.

4. The motor assembly of claim 1, wherein the microphone is a omni microphone, a directional microphone, or a conjoined microphone/receiver assembly.

5. A microphone comprising:
a motor assembly;
a housing comprising at least one opening, the motor assembly is disposed in the housing; and
a circuit attached to the outer surface of the housing, the circuit comprising at least one opening, the opening overlapping the opening of the housing, defining a passageway to permit acoustic coupling and electrical coupling.

6. The microphone of claim 5, wherein a second opening is formed on the housing, the second opening is adjacent to the motor assembly.

7. The microphone of claim 6, wherein the microphone is a directional microphone.

8. The microphone of claim 5, a main printed circuit board comprising an opening, the microphone is mounted directly to the main circuit board, wherein the opening of the main circuit board overlapping the openings of the housing and the circuit.

9. A diaphragm for a microphone, comprising:
a ring;
a metal layer; and
a film having a first surface and a second surface, the film is formed from a modified dielectric material having a uniform tension, wherein the ring is attached to a first surface and the metal layer is attached to the second surface.

10. The diaphragm of claim 9, wherein at least a portion of the metal layer formed on the second surface of the film is selectively removed and exposing a region beneath the removal portion.

11. The diaphragm of claim 10, wherein the metal layer is formed from a material selected from the group consisting of nickel, gold, titanium, chrome and combinations thereof.

12. A method of manufacturing a motor assembly for a microphone, comprising:
providing a modified dielectric material film;
attaching a metal layer to the film, forming a metallized film; and
stressing, heating, and cooling the metallized film until a tension is maintained uniformly throughout metallized film.

13. The method of claim 12, wherein the film is semi-crystallized polyphenylene sulfide.

14. The method of claim 12, further selectively removing a portion of the metal layer formed on the film using a direct energy source and exposing a region beneath the removal portion.

15. The method of claim 14, wherein the direct energy source is an excimer laser.

16. The method of claim 12, wherein the metal layer is selected from the group consisting of nickel, gold, titanium, chrome and combination thereof.

17. A method of manufacturing a microphone comprising:
providing a motor assembly;
providing a housing comprising at least one opening and disposing the motor assembly in the housing; and
attaching a circuit attached to the outer surface of the housing, the circuit comprising at least one opening, the opening overlapping the opening of the housing, defining a passageway to permit acoustic coupling and electrical coupling.

18. The method of claim 17, further forming a second opening on the housing wherein the second opening is adjacent to the motor assembly.

19. The method of claim 17, mounting a main printed circuit board to the housing, the main circuit board comprising an opening and the opening overlapping the openings of the housing and the circuit.

20. A method of manufacturing a motor assembly for a microphone, comprising:
providing a polyphenylene sulfide film;
attaching a metal layer to the film, forming a metallized polyphenylene sulfide film;
altering the crystallization of the metallized film, forming a metallized semi-crystallization polyphenylene sulfide film; and
stressing, heating, and cooling the metallized film until a tension is maintained uniformly throughout metallized film.

21. The method of claim 20, further selectively removing a portion of the metal layer formed on the film using a direct energy source and exposing a region beneath the removal portion.

22. The method of claim 21, wherein the direct energy source is an excimer laser.

23. The method of claim 21, wherein the metal layer is selected from the group consisting of nickel, gold, titanium, chrome and combination thereof.
